(19) United States
(12) Patent Application Publication
(10) Pub. No.: US 2022/0163630 A1
(43) Pub. Date: May 26, 2022

(54) SYSTEMS AND METHODS FOR RADAR DETECTION

(71) Applicant: ZENDAR INC., Berkeley, CA (US)

(72) Inventors: Antonio PUGLIELLI, Oakland, CA (US); Christopher BUCK, Berkeley, CA (US); Jas CONDLEY, Berkeley, CA (US); Osama SALEM, San Jose, CA (US); Ching Ming WANG, El Cerrito, CA (US); Vinayak NAGPAL, Berkeley, CA (US)

(21) Appl. No.: 17/534,185

(22) Filed: Nov. 23, 2021

Related U.S. Application Data
(60) Provisional application No. 63/117,272, filed on Nov. 23, 2020.

(51) Int. Cl. G01S 7/40; G01S 13/931; G01S 13/90

(52) U.S. Cl. CPC G01S 7/40; G01S 13/90; G01S 13/931

(57) ABSTRACT

The present disclosure provides systems and methods for radar detection. In an aspect, the present disclosure provides a system for radar detection. The system may comprise a plurality of radar sensors, a processor operatively coupled to the plurality of radar sensors, and an enclosure configured to house the processor and the plurality of radar sensors. In some embodiments, the plurality of radar sensors may be configured to provide a surround view of a surrounding environment external to the enclosure.

### CROSS-REFERENCE

This application claims priority to U.S. Provisional Patent Application No. 63/117,272 filed on Nov. 23, 2020, which application is incorporated herein by reference in its entirety for all purposes.

### BACKGROUND

RAdio Detection And Ranging (radar) can be used in many applications including object detection, range-finding, direction-finding and mapping. Traditionally, radar has been used in aerial vehicles, satellites, and maritime vessels to locate objects and image terrain. In recent years, radar has become increasingly popular in automobiles for applications such as blind-spot detection, collision avoidance, and autonomous driving. Unlike optical-based sensors (such as cameras or Light Detection and Ranging (LIDAR) systems) which are affected by changing weather and visibility, radar may be capable of functioning in low light conditions, in the dark, and under all types of weather conditions.

### SUMMARY

Recognized herein are various limitations with radar systems currently available. In order to take advantage of radar, vehicles may be equipped with multiple radar sensors to detect obstacles and objects in the surrounding environment. However, the multiple radar sensors in current radar systems may not provide a comprehensive surround view of the surrounding environment in which a vehicle is located. Provided herein are systems and methods for surround view radar detection. The performance and robustness of radar systems may be improved by using a plurality of radar sensors with a plurality of fields of view to aid in the perception, detection, and/or classification of objects or obstacles in a surrounding environment.

Additionally, the multiple radar sensors in current radar systems may typically process data independently of one another. Provided herein are systems and methods for processing and combining radar data. The performance and robustness of radar systems may be improved by combining data from multiple radar sensors and/or modules prior to the perception, detection, and/or classification of objects or obstacles in a surrounding environment. Further, the radar systems disclosed herein may be configured to resolve computational ambiguities involved with processing and coherently combining radar data from multiple radar sensors and/or modules, in order to identify nearby objects or obstacles and generate surround view radar detection.

In one aspect, the present disclosure provides a system for surround view radar detection. The system may comprise a plurality of radar sensors, a common or single processor and computer memory coupled thereto, operatively coupled to the plurality of radar sensors, and at least one mechanical enclosure configured to house the common or single processor and the plurality of radar sensors. The computer memory comprises machine executable code that, upon execution by the common or single computer processor, implements any of the methods above or elsewhere herein. In some embodiments, the plurality of radar sensors may be configured to provide a surround view of a surrounding environment external to the mechanical enclosure.

Another aspect of the present disclosure provides a system for surround view radar detection that may comprise a plurality of radar sensors, a common or single processor operatively coupled to the plurality of radar sensors, and a plurality of mechanical enclosures configured to house the common or single processor and the plurality of radar sensors. In some embodiments, the plurality of mechanical enclosures may include 1, 2, 3, 4 or more enclosures, each part of the system, each housing having 1 or more radar sensors and optionally the common or single processor or one of the one or more computer processors, operatively coupled to the plurality of radar sensors. In some embodiments, the plurality of radar sensors may be configured to provide a surround view of a surrounding environment external to the mechanical enclosure.

Another aspect of the present disclosure provides methods and systems for detecting objects in proximity to a vehicle, along or in proximity to a travel path of a vehicle, and/or in a field of view (or alternately field-of-view) of the vehicle. The vehicle may be a terrestrial vehicle (e.g., a car or a bus, a robot, and/or industrial equipment or machinery; e.g., mining or agricultural equipment or machinery).

A high-resolution radar system as disclosed herein can be a radar system capable of distinguishing between multiple targets that are very close to one another in either range and/or bearing, with respect to the radar system. The radar system may achieve higher resolution by improving range resolution, azimuth resolution, elevation resolution, or any combination thereof. Range resolution is the ability of a radar system to distinguish between two or more targets on the same bearing but at different ranges. Azimuth resolution is the ability of a radar system to distinguish between objects at similar range but different bearings. Elevation resolution is the ability of a radar system to distinguish between objects at similar range but different elevation. Range resolution may be a function of bandwidth, while azimuth and elevation resolution may be a function of radar array geometry. The radar system can accurately detect targets and/or characteristics of targets if it can sense the presence of one or more targets, distinguish one or more targets as separate targets, and/or determine some physical properties of one or more targets.

In some embodiments, the radar system disclosed herein can be implemented using any radar antenna array (for example, millimeter wavelength radar antenna arrays that are relatively low cost, compact and readily commercially available). The radar system disclosed herein can also enable accurate measurement and tracking of vehicle position by using returns from the radar antenna array. In some cases, the radar system may be a Synthetic Aperture Radar (SAR) system that is adapted for use on terrestrial vehicles. Alternatively, the radar system may incorporate one or more elements of a SAR system. A SAR system as disclosed herein can provide high resolution radar imagery from a moving terrestrial platform or terrestrial vehicle. A SAR system may utilize accurate measurement and tracking of the terrestrial vehicle position to transform raw radar returns into focused images. To achieve reliable SAR imaging and accurate measurements of vehicle and/or target positions, the spatial configuration of the SAR system may be fixed or adjusted based on a wavelength of a radar signal or a fraction of a wavelength of a radar signal.

In another aspect, the present disclosure provides a method for determining a spatial disposition or a characteristic of a target external to a terrestrial vehicle while the terrestrial vehicle is in motion. The method may comprise (a) using a synthetic aperture radar onboard the terrestrial vehicle to collect radar signals having (i) an azimuth resolution within from about 0.05 degrees to 1 degree and (ii) an elevation resolution within from about 0.1 degrees to 15 degrees when the target (1) has a size of at least 0.2 meters, (2) is located within a field of view of the terrestrial vehicle in a forward or rear facing direction of the terrestrial vehicle, and (3) is at a distance of at least about 1 meter from the terrestrial vehicle; and (b) using said radar signals to determine (i) the spatial disposition of the target relative to the terrestrial vehicle or (ii) the characteristic of the target.

In another aspect, the present disclosure provides a method for determining a spatial disposition or a characteristic of a target external to a terrestrial vehicle while the terrestrial vehicle is in motion. The method may comprise (a) using a synthetic aperture radar onboard the terrestrial vehicle to collect radar signals having (i) an azimuth resolution within from about 0.05 degrees to 1 degree and (ii) an elevation resolution within from about 15 degrees to 90 degrees when the target (1) has a size of at least 0.2 meters, (2) is located within a field of view of the terrestrial vehicle in a side facing direction of the terrestrial vehicle, and (3) is at a distance of at least about 1 meter from the terrestrial vehicle; and (b) using the radar signals to determine (i) the spatial disposition of the target relative to the terrestrial vehicle or (ii) the characteristic of the target.

In another aspect, the present disclosure provides a method for determining a spatial disposition or a characteristic of a target external to a terrestrial vehicle. The method may comprise (a) providing a radar antenna array on the terrestrial vehicle, wherein the radar antenna array comprises a transmitting antenna and a receiving antenna; (b) obtaining, with aid of a vehicle position sensor, a spatial disposition of the terrestrial vehicle; and (c) with aid of a controller operatively coupled to the radar antenna array and the vehicle position sensor: (1) synchronizing (i) successive radar pulses transmitted by the transmitting antenna and a plurality of signals received by the receiving antenna, which plurality of signals may correspond to at least a subset of the successive radar pulses and may be generated upon the at least a subset of the successive radar pulses interacting with the target, with (ii) the spatial disposition of the terrestrial vehicle obtained by the vehicle position sensor substantially in real time as the terrestrial vehicle is in motion, to generate a set of synchronized measurements; and (2) using the set of synchronized measurements to determine (i) the spatial disposition of the target relative to the terrestrial vehicle or (ii) the characteristic of the target. In some cases, the method may further comprise, in (a), providing the transmitting antenna and the receiving antenna in a fixed spatial configuration on the terrestrial vehicle. The set of synchronized measurements may be generated based at least in part on the fixed spatial configuration of the transmitting antenna and the receiving antenna. Alternatively, the spatial disposition of the target relative to the terrestrial vehicle or the characteristic of target may be determined substantially in real time while the terrestrial vehicle is moving relative to the target when the target is stationary or in motion. In some embodiments, the method may further comprise, in (c), processing (i) a first spatial disposition of the target as calculated from a first side of the terrestrial vehicle or using a first radar antenna array, against (ii) a second spatial disposition of the target as calculated from a second side of the terrestrial vehicle or using a second radar antenna array, wherein the radar antenna array comprises the first and second radar antenna arrays.

Another aspect of the present disclosure provides a non-transitory computer readable medium comprising machine executable code that, upon execution by the common or single processor, or one or more computer processors, implements any of the methods above or elsewhere herein.

In some embodiments, the first set of radar signals may be transmitted by a first radar sensor or module and the second set of radar signals may be received at a second radar sensor or module. In some embodiments, the second set of radar signals may correspond to a subset of the first set of radar signals that is transmitted by the first radar sensor or module and reflected from the at least one object in the surrounding environment. In some embodiments, the second radar sensor or module may be configured to pre-process the second set of radar signals before providing the second set of radar signals to a processor for coherent combination with an additional second set of radar signals received at a third radar sensor or module.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates a mechanical enclosure for housing a surround view radar system, in accordance with some embodiments.

FIG. 2 schematically illustrates a radar printed circuit board (PCB) within a mechanical enclosure, in accordance with some embodiments.

FIG. 3 schematically illustrates a processor printed circuit board (PCB) within a mechanical enclosure, in accordance with some embodiments.

FIG. 4 schematically illustrates a side view of a surround view radar system within a mechanical enclosure, in accordance with some embodiments.

FIG. 5 schematically illustrates a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “real time” or “real-time,” as used interchangeably herein, generally refers to an event (e.g., an operation, a process, a method, a technique, a computation, a calculation, an analysis, a visualization, an optimization, etc.) that is performed using recently obtained (e.g., collected or received) data. In some cases, a real time event may be performed almost immediately or within a short enough time span, such as within at least 0.0001 millisecond (ms), 0.0005 ms, 0.001 ms, 0.005 ms, 0.01 ms, 0.05 ms, 0.1 ms, 0.5 ms, 1 ms, 5 ms, 0.01 seconds, 0.05 seconds, 0.1 seconds, 0.5 seconds, 1 second, or more. In some cases, a real time event may be performed almost immediately or within a short enough time span, such as within at most 1 second, 0.5 seconds, 0.1 seconds, 0.05 seconds, 0.01 seconds, 5 ms, 1 ms, 0.5 ms, 0.1 ms, 0.05 ms, 0.01 ms, 0.005 ms, 0.001 ms, 0.0005 ms, 0.0001 ms, or less.

The term “enclosure” or “mechanical enclosure,” as use interchangeably herein, generally refers to an enclosure configured to house components of the radar system enclosed and/or integrated within.

The term “radar sensor” or “radar module,” as used interchangeably herein, generally refers to an electromagnetic sensor or conversion device that can convert microwave echo signals into electrical signals. Radar sensing is a wireless sensing technology that extracts and discovers a target's position, shape, motion characteristics and motion trajectory by analyzing the received target echo characteristics. A radar sensor may include a transmitting and receiving antennae and an indicator, as a non-limiting example, whereas a radar module may also include additional components such as circuit boards, local oscillator, driver, modulator and power amplifier, as non-limiting examples, and may be configured to be easily installed as a combination component into a larger system. In some embodiments, the sensor and the module are interchangeable unless otherwise stated herein.

Surround View Radar System

In an aspect, the present disclosure provides a radar system for object detection, mapping, and vehicle navigation. The radar system may comprise one or more components or features of the radar systems disclosed in U.S. Pat. Nos. 10,365,364; 10,371,797; 10,775,481; PCT International Application Publication No. WO/2020/226720; and PCT International Application Publication No. WO/2020/222948, each of which is incorporated herein by reference in its entirety for all purposes.

The radar system may comprise a surround view radar system. The surround view radar system may comprise one or more radar sensors operatively coupled to a processor. The surround view radar system may not or need not require a System-on-Chip (SoC) architecture or design. The surround view radar system may be configured to provide radar detection capabilities spanning 360 degrees around a vehicle on which the surround view radar system is mounted.

The system may comprise a plurality of radar modules. The plurality of radar modules may comprise a radar sensor or module. The radar sensor or module may comprise a radar transmitter and/or a radar receiver. The radar transmitter may comprise a transmitting antenna. The radar receiver may comprise a receiving antenna. A transmitting antenna may be any antenna (dipole, directional, patch, sector, Yagi, parabolic, grid) that can convert electrical signals into electromagnetic waves and transmit the electromagnetic waves. A receiving antenna may be any antenna (dipole, directional, patch, sector, Yagi, parabolic, grid) that can receive electromagnetic waves and convert the radiofrequency radiation waves into electrical signals. In some cases, the radar sensor or module may include one or more transmitting antennas and/or one or more receiving antennas. In some cases, the radar sensor or module may have a plurality of RX and/or TX channels. The radar sensor or module may be used to detect one or more targets in a surrounding environment.

In some embodiments, a terrestrial vehicle may be configured to operate in a surrounding environment. A surrounding environment may be a location and/or setting in which the vehicle may operate. A surrounding environment may be an indoor or outdoor space. A surrounding environment may be an urban, suburban, or rural setting. A surrounding environment may be a high altitude or low altitude setting. A surrounding environment may include settings that provide poor visibility (nighttime, heavy precipitation, fog, particulates in the air).

In some embodiments, the terrestrial vehicle may be an autonomous vehicle. An autonomous vehicle may be an unmanned vehicle. The autonomous vehicle may or may not have a passenger or operator on-board the vehicle. The autonomous vehicle may or may not have a space within which a passenger may ride. The autonomous vehicle may or may not have space for cargo or objects to be carried by the vehicle. The autonomous vehicle may or may not have tools that may permit the vehicle to interact with the environment (e.g., collect samples, move objects). The autonomous vehicle may or may not have objects that may be emitted to be dispersed to the environment (e.g., light, sound, liquids, pesticides). The autonomous vehicle may operate without requiring a human operator. The autonomous vehicle may be a fully autonomous vehicle and/or a partially autonomous vehicle.

A surrounding environment may include features that are on or near a travel path of a vehicle. In some cases, a surrounding environment may include features that are outside of a travel path of a vehicle. Features may include markings and/or signals relevant for driving, such as road signs, lane markings, and/or traffic lights. In some cases, features may be objects external to the vehicle. For example, features may be a living being or an inanimate object. In some cases, a feature may be a pedestrian, an animal, a vehicle, a building, a signpost, a sidewalk, a sidewalk curb, a fence, a tree, or any object that may obstruct a vehicle traveling in any given direction. A feature may be stationary, moving, or capable of movement. A feature may be located in the front, rear, or lateral side of the vehicle. A feature may be positioned at a range of at least about 1 meter (m), 2 m, 3 m, 4 m, 5 m, 10 m, 15 m, 20 m, 25 m, 50 m, 75 m, or 100 m from the vehicle. A feature may be located on the ground, in the water, or in the air within the environment. A feature may be oriented in any direction relative to the vehicle. A feature may be orientated to face the vehicle or oriented to face away from the vehicle at an angle ranging from 0 to about 360 degrees. Features may include multiple features external to a vehicle within the environment.

A feature may have a spatial disposition or characteristic that may be measured or detected by sensors employed within the SAR-based system. Spatial disposition information may include information about the position, velocity, acceleration, and other kinematic properties of the target relative to the vehicle. A characteristic of a feature may include information on the size, shape, orientation, and material properties, such as reflectivity, of the feature.

Mechanical Enclosure

The components of the radar system may be enclosed and/or integrated within one or more mechanical enclosures as part of the system. The one or more mechanical enclosures may be mounted on a terrestrial vehicle, a robot, and/or industrial equipment or machinery (e.g., mining or agricultural equipment or machinery).

The mechanical enclosure(s) may comprise a box or a cylinder. In cases where the mechanical enclosure is in the form of a box, the nominal enclosure dimensions may be about 7 inches by 7 inches by 6 inches. The mechanical enclosure by itself may weigh between about 0.1 pounds and about 10.0 pounds. In some cases, the mechanical enclosure by itself may weigh between about 0.5 pound and about 4.0 pounds. In some cases, the mechanical enclosure with all or some of the radar system components integrated therein may weigh between about 0.1 pounds and about 10.0 pounds. In some cases, the mechanical enclosure with all or some of the radar system components integrated therein may weigh between about 0.5 pound and about 4.0 pounds.

In cases where the mechanical enclosure(s) is in the form of a cylinder or puck, the nominal enclosure dimensions may be between 3 inches and 9 inches in diameter by between 2 inches by 8 inches in height. The mechanical enclosure by itself may weigh between about 0.1 pounds and about 10.0 pounds. In some cases, the mechanical enclosure by itself may weigh between about 0.5 pound and about 4.0 pounds. In some cases, the mechanical enclosure with all or some of the radar system components integrated therein may weigh between about 0.1 pounds and about 10 pounds. In some cases, the mechanical enclosure with all or some of the radar system components integrated therein may weigh between about 0.5 pound and about 4.0 pounds. The mechanical enclosure(s) may alternately comprise other shapes or configurations, without limitation, such as cube, cuboid, cone, cylinder, sphere, pyramid, prism, and so on.

In any configuration of the radar system described herein, where there are two or more mechanical enclosures, the two or more enclosures need not be the same shape or configuration.

Electrical Design

The one or more radar sensors may be operatively coupled to a processor. In some cases, the radar sensors may be integrated into and/or operatively coupled to one or more circuit boards that are separate from and/or different than a circuit board that the processor is integrated into and/or operatively coupled to. In other cases, the radar sensors may be integrated into and/or operatively coupled to the same circuit board that the processor is integrated into and/or operatively coupled to.

In some cases, the radar sensors may be configured to provide data to the processor over a digital interface. In some cases, the digital interface may comprise a standardized electrical interface, such as a MIPI CSI-2 electrical bus.

In some cases, the radar sensors may be connected to the processor via cables or board-to-board connectors. In some cases, the radar sensors may be implemented on the same circuit board as the processor.

In some cases, the radar sensors may be implemented on one or more flex or rigid-flex circuit boards. Flex circuit boards may allow for more varied and compact placement and orientation of the circuit boards.

In some cases, the radar sensors and the processor may be powered using a common power supply. The nominal power draw or power consumption may range from about 2 Watts to about 3 Watts for each radar sensor, and about 10 Watts to about 20 Watts for the processor. In some cases, the processor may have a nominal power draw or power consumption of about 15 Watts.

Radar Operation

In some embodiments, one or more common time synchronization signals and/or one or more common frequency synchronization signals may be provided to each radar sensor. In some embodiments, the radar sensors may be operated with one or more same modulation parameters. Alternatively, the radar sensors may be operating with one or more different modulation parameters.

In some embodiments, each radar sensor may have a field of view that ranges from about 60 degrees to about 180 degrees. In some cases, the fields of view for the radar sensors may be immediately adjacent or coincident, overlapping or partially overlapping. In other cases, the fields of view for the radar sensors may be non-overlapping. Collectively, the plurality of radar sensors may be configured to provide full 360-degree coverage relative to a vehicle on which the plurality of radar sensors are mounted. In some cases, the plurality of radar sensors may provide between about 180 degrees and about 360 degrees of coverage relative to the vehicle on which the plurality of radar sensors are mounted.

In some embodiments, the processor is configured to calibrate the mounting positions and angles together for the plurality of radar sensors using the overlapping field of view on the CPU.

Mechanical Design

In some embodiments, the mechanical enclosure may be configured to dissipate heat generated by one or more internal components (e.g., the processor and/or the plurality of radar sensors operatively coupled to the processor). The mechanical enclosure may be configured to dissipate heat generated when the radar system is operating with a nominal power budget of about 30 Watts, which may correspond to an operating temperature of at least 100 degrees Celsius if not cooled. In some cases, one or more cooling techniques may be used to maintain the operating temperature of the radar system within a predetermined temperature range. The one or more cooling techniques may comprise, for example, the use of a heat sink, a heat spreader, a fan, one or more cooling pipes or cooling tubes, and/or liquid cooling.

In some cases, the radar sensors and/or the processor may be provided on one or more integrated circuits. The one or more integrated circuits may comprise a heat sink or a heat spreader that is in physical contact with or in thermal communication with one or more conductive portions of the mechanical enclosure. The heat sink or heat spreader may comprise a metallic material, such as copper or aluminum, which is machined or injection molded into a desired shape or profile. The heat sink or heat spreader may be sized and/or shaped to make physical contact with the heat-generating integrated circuits (ICs) through a thermal paste that is applied to a portion of the heat-generating integrated circuits (ICs) and/or the heat sink or heat spreader. In any of the embodiments described herein, the conductive or metal parts of the enclosure may be configured to control and minimize the interaction between metal portions of the enclosure and metal structures of the antennas that affects a transmission and/or a reception of one or more radar signals. In some cases, such interaction may be minimized or prevent by a physical clearance between the mechanical enclosure and the antennas of the radar system. In some cases, the heat sink or heat spreader may be coupled with a fan that provides active airflow over the cooling structures.

In some embodiments, the mechanical enclosure may comprise one or more dielectric materials. In such cases, at least a portion of the mechanical enclosure may be designed to be transparent at an operating frequency of the radar. In some cases, the entire mechanical enclosure may be designed to be transparent at an operating frequency of the radar. In some embodiments, at least a portion of the mechanical enclosure may be designed to be semi-transparent to optical wavelengths with relatively low loss to the 77-81 GHz operating frequency of the radar. In some embodiments, the entire mechanical enclosure may be designed to be semi-transparent to optical wavelengths with relatively low loss to the 77-81 GHz operating frequency of the radar.

The radar sensors may be mounted at a predetermined distance behind a surface of the enclosure. In some cases, the radar sensors may be mounted between about 1 millimeter and about 10 millimeters from an inner wall of the enclosure.

The mechanical enclosure may have a predetermined thickness to ensure optimal radar signal propagation. In some cases, the thickness of one or more walls or surfaces of the mechanical enclosure may be less than about 4 millimeters.

In some cases, the integrated circuits may be heat-sinked to one or more fans inside the enclosure. In some cases, the enclosure may be equipped with one or more vents for air circulation. The one or more vents may be protected by baffles or other external features to prevent water ingress or directional water ingress. In some cases, the enclosure may include additional features to ensure that it is weatherproof (i.e., insulated or protected from water and snow ingress).

In some embodiments, the mechanical enclosure(s) comprising the surround view radar system components may be configured to be mounted to a front side, rear side, or lateral side of the terrestrial vehicle.

System Operation

The processor may be configured to take in data from each radar sensor and process the data received from each radar sensor to detect one or more characteristics of one or more targets within a surrounding environment. The vehicle may be moving or stationary within the surrounding environment. The one or more characteristics may include, for example, a position, a velocity, an acceleration, a shape, a size, and/or a material of the one or more objects.

In some cases, the processor may be configured to jointly process and combine data across one or more radar sensors. In some cases, the processor may be configured to aggregate independent (i.e., non-overlapping) points or images from each radar sensor. In some cases, the processor may be configured to resolve overlapping fields of view of radar sensors by combining points or images from one or more radar sensors. In some cases, the processor may be configured to jointly process raw or low-level radar data (coherently or non-coherently) to compute a common point, image, and/or property of a target object.

In some embodiments, the processor may be used to configure the radars and trigger one or more transmit and receive firing patterns associated with the operation of the radars. In some cases, the processor may be configured to synchronize or time-align radar returns. In some cases, the processor may be configured to compensate for differences between radars. For example, the processor may be configured to perform or implement a factory or online calibration of radar data, a factory or online calibration of radar sensor positions, or an online tracking of temperature or other environmental or electrical characteristics associated with the operation of the radars. Such tracking of environmental or electrical characteristics may be performed using onboard environmental sensors, such as a temperature sensor, a humidity sensor, and/or an electromagnetic field sensor.

In some embodiments, the processor may be configured to compensate for interactions between radar signals. For example, the processor may be configured to remove interference between radars in the data, trigger each radar to fire at different times to avoid interference, and/or program the radars to fire in different frequency bands to avoid interference. The radar systems disclosed herein may be configured to operate between about 76 GHz and about 81 GHz. In one example, a first radar may fire at about 76 GHz to about 77 GHz, and a second radar may fire at about 77 GHz to about 78 GHz. In another example, two or more radars may fire at different frequencies that lie within the operational range of the radar system (i.e., between about 76 GHz and about 81 GHz).

In some embodiments, the processor may be configured to take in data from positioning sensors (e.g., GPS, IMU, etc.) and to fuse the positioning data with radar data. The positioning sensors may be internal to the surround view radar sensor or module. In some cases, a data interface may be provided to take in external positioning sensor data (raw or processed).

In some embodiments, the processor may be configured to synchronize radar firing or data output based on an external signal. The external signal may comprise, for example, a periodic signal, such as a square-wave. In some cases, the external signal may comprise a signal from a digital (e.g., serial) bus where a serial message indicates a firing trigger.

Interface Details

In some embodiments, the processor may be used to generate processed radar data (as point clouds or images of the environment) through an interface to an external unit. In some embodiments, the processor may be configured to provide a common and cohesive data-based representation of the environment through the data interface. In some cases, a single power connection may be used to provide power to all internal components of the radar system, including the processor and/or the radar sensors. In some cases, an optional positioning interface may be used to receive positioning sensor data from one or more components of the radar system or provide positioning sensor data to one or more components of the radar system. The positioning sensor data may be received and/or provided over a same network link as the radar data output (e.g., Ethernet).

In some embodiments, a control/status interface may be provided to the outside controller to enable configuration and/or monitoring of the system. This may be over the same link as the radar data output (e.g., Ethernet). The control/status interface may be used to allow the controller to configure and monitor the radar system, based on data received using one or more sensors (e.g., the radar sensors and/or the positioning sensors). In some cases, the control/status interface may be located in the vehicle. In other cases, the control/status interface may be located remote from the vehicle. The outside controller may be located onboard the vehicle but separate (i.e., outside) of the mechanical enclosure.

The controller may be used to synchronize measurements taken by the system. The controller may be implemented onboard the terrestrial vehicle or off-site on a server. The controller may comprise a computer processor, application specific integrated circuit, a graphics processing unit, or a field programmable gate array. In some embodiments, the controller may be configured to obtain a first set of measurements from a radar antenna array. The first set of measurements may be based on successive radar pulses transmitted by the transmitting antenna and a plurality of signals received by the receiving antenna. The plurality of signals received by the receiving antenna may include a subset of the successive radar pulses that are transmitted by the transmitting antenna and reflected back to the receiving antenna after interacting with external targets. The controller can also be configured to obtain a second set of measurements from a vehicle position sensor. The second set of measurements may include information on the spatial disposition of a vehicle. The vehicle position sensor may obtain a spatial disposition of a terrestrial vehicle in real time. The terrestrial vehicle may be stationary or in motion. The controller may also be configured to synchronize the first set of measurements with the second set of measurements to generate a set of synchronized measurements. The synchronized measurements may be generated based at least in part on a fixed spatial configuration of one or more receiving antennas and/or one or more transmitting antennas. The controller may be further configured to use the synchronized measurements to determine a spatial disposition of a target or a characteristic of a target.

In some cases, synchronization may be achieved by using phase shift measurements to determine changes in vehicle position or target position. Phase measurements may be measurements of the difference in phase between a first signal transmitted by a transmitting antenna and a second signal received by a receiving antenna. The second signal may be a subset of the first signal reflected off a target after the first signal interacts with the target. Alternatively, synchronization may be achieved through any combination of the synchronization methods described herein.

In some embodiments, the controller may be configured to control the pulse repetition frequency of successive radar pulses transmitted by a transmitting antenna. The pulse repetition frequency may be approximately equal to the inverse of the time duration for a terrestrial vehicle to travel a fraction of the wavelength of the transmitted radar pulses. The wavelength of the transmitted radar pulse may range from 3 mm to 4 mm. The wavelength of the transmitted radar pulse may be less than or equal to 3 mm. The wavelength of the transmitted radar pulse may be greater than or equal to 4 mm. A fraction of the wavelength may be less than or equal to about 1, 0.75, 0.67, 0.5, 0.33, 0.25, 0.2, or 0.1 of the wavelength. In some cases, a fraction of the wavelength described herein may be greater than 1. For example, a fraction of the wavelength may be at least about 1.25, 1.5, 1.75, 2, 3, 4, 5, 6, 7, 8, 9, or 10 times the wavelength.

In some embodiments, the controller may also be configured to pre-process signals received from the transmitting antenna, the receiving antenna, or the vehicle position sensor to reduce the bandwidth of received signals before calculating the spatial disposition or characteristic of an external target. Pre-processing can include peak-detection methods, Fourier transform methods, filtering methods, smoothing methods, or any other methods that are used to modify or transform a signal.

In some embodiments, the controller may be configured to synchronize signals received from the transmitting antenna, receiving antenna, or vehicle position sensor, either relative to each other or relative to an absolute time, using one or more clocks that may be provided on at least one of a radar antenna array or a vehicle position sensor.

In some embodiments, the controller may be configured to calculate a spatial disposition or characteristic of each of a plurality of targets external to a terrestrial vehicle.

In some embodiments, the mechanical enclosure may be able to decouple the one or more transmitting and/or receiving antennas from vibrations, shocks, or impacts experienced by a vehicle in motion. In some embodiments, the fixed spatial configuration may also be modified or controlled by a mechanism configured to adjust and/or calibrate the alignment or location of one or more transmitting and/or receiving antennas. The mechanism may be an open loop control system, a closed loop control system, a feedback loop system, a feedforward loop system, or any combination thereof.

In some cases, the plurality of radar sensors or modules may be configured to forward the plurality of incoming radar pulses to the processor for signal aggregation (e.g., aggregation of the plurality of incoming radar pulses and/or aggregation of the second sets of radar signals received by each of the plurality of radar sensors or modules). In such cases, the processor may be configured to generate timestamps for the plurality of incoming radar pulses received by each of the plurality of radar sensors or modules using the shared clock signal generated by the timing module. The timestamps generated by the processor may be generated relative to one or more ticks of the shared clock signal. In some cases, the processor may be configured to use the timestamps generated by the processor to chronologically sort the plurality of incoming radar pulses received by each of the plurality of radar sensors or modules.

In other cases, each of the plurality of radar sensor or modules may comprise a timestamp generator. The timestamp generator may be configured to label at least a subset of the plurality of incoming radar pulses respectively received by each of the plurality of radar sensors or modules with a timestamp relative to the shared clock signal or a timing signal associated with each of the plurality of radar sensor or modules. In some cases, the timestamp generator may be configured to timestamp the at least a subset of the plurality of incoming radar pulses respectively received by each of the plurality of radar sensors or modules before the plurality of radar sensors or modules forward the plurality of incoming radar pulses to a processor for signal aggregation. In such cases, the processor may be configured to use the timestamps generated by the timestamp generate to chronologically sort the plurality of incoming radar pulses received by each of the plurality of radar sensors or modules.

In some cases, the plurality of radar sensors or modules may be configured to forward the plurality of incoming radar pulses to the processor for signal aggregation (e.g., aggregation of the plurality of incoming radar pulses and/or aggregation of the second sets of radar signals received by each of the plurality of radar sensors or modules). In some cases, the plurality of radar sensors or modules may be configured to calibrate the second sets of radar signals received by each of the plurality of radar sensors or modules, before forwarding the second sets of radar signals to the processor.

In some cases, the plurality of radar sensors or modules may be configured to apply a correction to the second sets of radar signals based on estimated calibration parameters. Alternatively, the plurality of radar sensors or modules may be configured to provide the estimated calibration parameters for the second sets of radar signals to the processor without applying any correction to the second sets of radar signals. In such cases, the processor may be configured to modify and/or correct the second sets of radar signals using the estimated calibration parameters received from the plurality of radar sensors or modules. The estimated calibration parameters may be derived in part from one or more variations in phase, gain, delay, frequency, and/or bias observed between two or more incoming radar pulses of the plurality of incoming radar pulses. In some cases, the estimated calibration parameters may be derived in part based on the relative spatial positions or relative spatial orientations of the plurality of radar sensors or modules.

In some cases, the plurality of radar sensors or modules may be configured to calibrate the second sets of radar signals using known objects that are visible to each of the plurality of radar sensors or modules in order to identify phase, gain, delay, frequency, or bias differences between two or more incoming radar pulses of the second sets of radar signals received by each of the plurality of radar sensors or modules. Each radar sensors or module may use a calibration procedure. The calibration procedure may comprise a factory calibration, a lab calibration, and/or an online (e.g., a real-time) calibration algorithm. The calibration procedure used for one radar sensors or module of the plurality of radar sensors or modules may or may not be substantially similar to the calibration procedure used for another radar sensors or module of the plurality of radar sensors or modules. The calibration procedure used for one radar sensors or module of the plurality of radar sensors or modules may or may not be different than the calibration procedure used for another radar sensors or module of the plurality of radar sensors or modules.

In some cases, the processor is configured to calibrate the timing signals associated with each of the plurality of radar sensors or modules.

Applications

The systems and methods of the present disclosure may be used to implement multiple surround-view radar systems that may be operated jointly on the same vehicle, platform, and/or robot. In some cases, the multiple surround-view radars may be operated independently from one another. In some cases, the multiple radar systems can be synchronized via software algorithms running on one or more of the radar systems, or on a separate common processor. In some cases, the multiple radar systems may share one or more hardware synchronization signals.

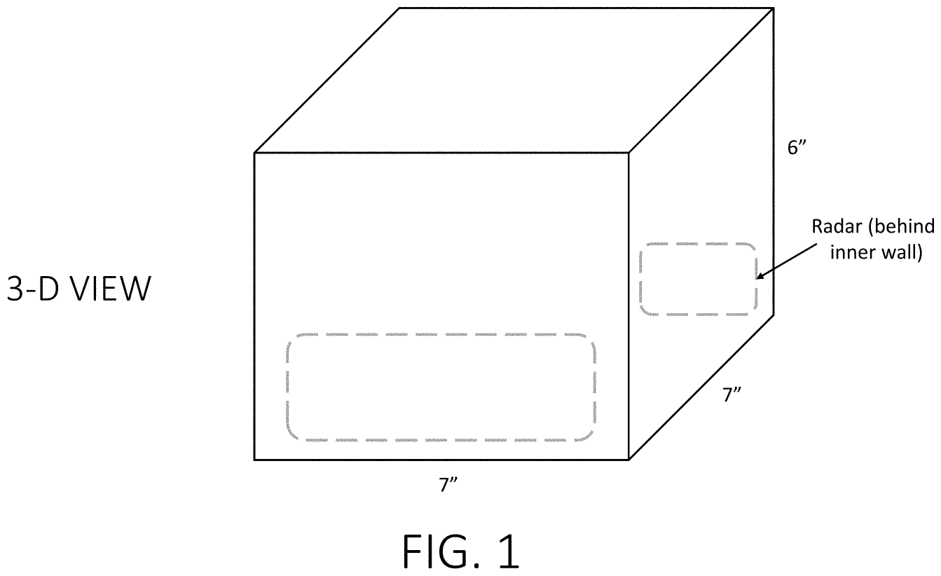

FIG. 1 schematically illustrates a mechanical enclosure for housing a surround view radar system. In some embodiments, the mechanical enclosure may be in the shape of a box with dimensions of 7 inches by 7 inches by 6 inches. One or more radar sensors may be mounted behind an inner wall of the mechanical enclosure.

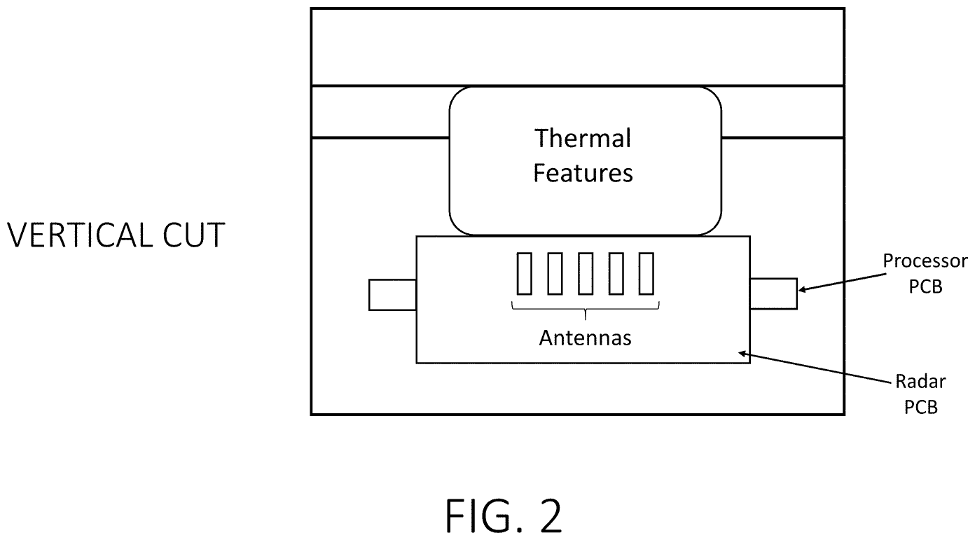

FIG. 2 schematically illustrates a radar printed circuit board (PCB) within a mechanical enclosure, in accordance with some embodiments. One or more radar sensors comprising a plurality of antennas may be integrated with and/or operably coupled to the radar PCB. The radar system may further comprise a processor that is integrated with and/or operably coupled to a processor PCB. In some embodiments, one or more thermal features may be provided for thermal management or heat dissipation of heat generated due to an operation of the radar system or one or more components of the radar system (e.g., one or more radar sensors, one or more processors, and/or one or more printed circuit boards).

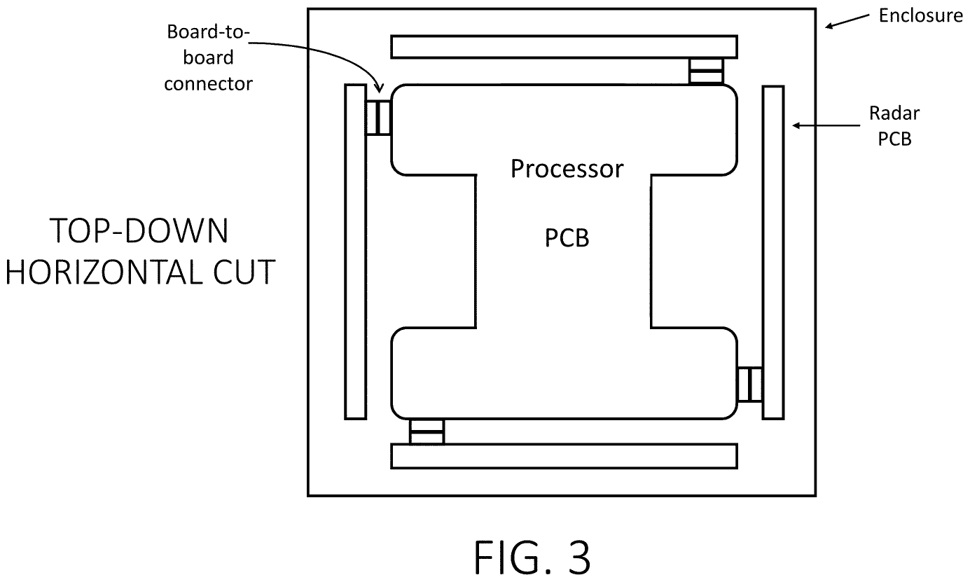

FIG. 3 schematically illustrates a processor printed circuit board (PCB) within a mechanical enclosure, in accordance with some embodiments. The processor PCB may be in communication with one or more radar PCBs via one or more board-to-board connectors.

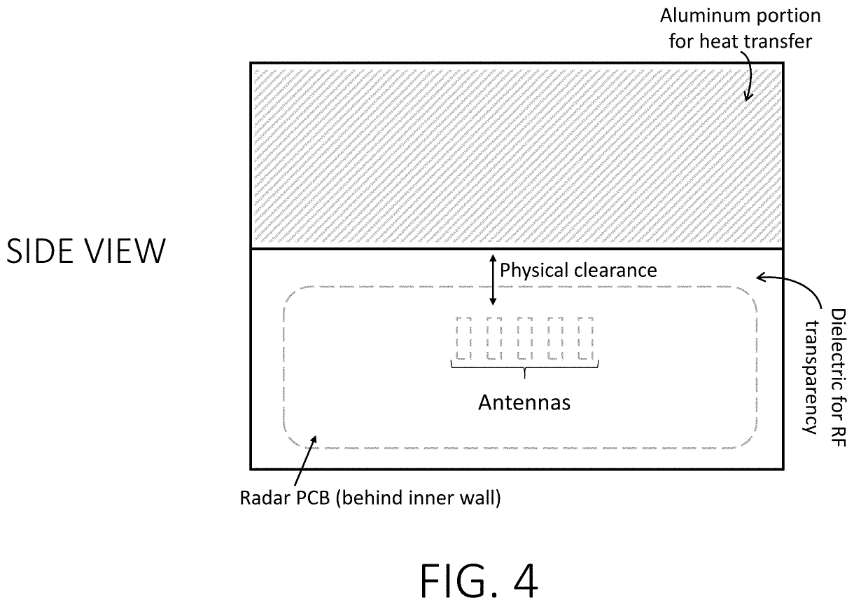

FIG. 4 schematically illustrates a side view of a surround view radar system within a mechanical enclosure, in accordance with some embodiments. The surround view radar system may comprise one or more radar PCBs positioned behind an inner wall of the mechanical enclosure. One or more radar sensors comprising a plurality of antennas may be integrated with and/or operatively coupled to the one or more radar PCBs. The plurality of antennas may be positioned and oriented within the mechanical enclosure such that a physical clearance is maintained between the antennas and the inner walls of the mechanical enclosure. In some cases, one or more heat sinks may be in physical contact with or in thermal communication with (i) one or more conductive portions of the mechanical enclosure and/or (ii) one or more components of the radar system (e.g., one or more PCBs of the radar system). The one or more heat sinks may comprise a metallic material, such as copper or aluminum, which is machined or injection molded into a desired shape or profile. The one or more heat sinks may be sized and/or shaped to make physical contact with the heat-generating integrated circuits (ICs) through a thermal paste that is applied to a portion of the heat-generating integrated circuits (ICs) and/or the heat sink or heat spreader. In any of the embodiments described herein, the conductive or metal parts of the enclosure may be configured to minimize or prevent interference with radar transmitting antennas and/or radar receiving antennas. In some embodiments, the mechanical enclosure may comprise one or more dielectric materials. In such cases, at least a portion of the mechanical enclosure may be designed to be transparent at an operating frequency of the radar. In some cases, the entire mechanical enclosure may be designed to be transparent at an operating frequency of the radar. In some embodiments, at least a portion of the mechanical enclosure may be designed to be semi-transparent to optical wavelengths with relatively low loss to the 77-81 GHz operating frequency of the radar. In some embodiments, the entire mechanical enclosure may be designed to be semi-transparent to optical wavelengths with relatively low loss to the 77-81 GHz operating frequency of the radar.

Computer Systems

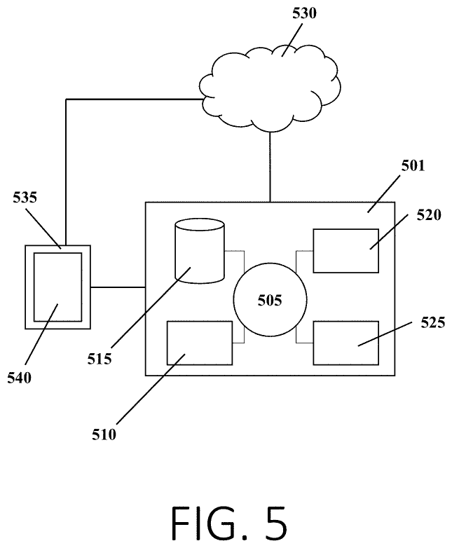

In an aspect, the present disclosure provides computer systems that are programmed or otherwise configured to implement methods of the disclosure, e.g., any of the subject methods for radar detection. FIG. 5 shows a computer system 501 that is programmed or otherwise configured to implement a method for radar detection. The computer system 501 may be configured to, for example, process a plurality of radar signals obtained using one or more radar sensors of the surround view radar systems disclosed herein, and detect one or more objects based on the plurality of processed radar signals. The computer system 501 can be an electronic device of a user or a computer system that is remotely located with respect to the electronic device. The electronic device can be a mobile electronic device.

In some embodiments, the processor is configured to calibrate the mounting positions and angles together for the plurality of radar sensors using the overlapping field of view on the computer.

The computer system 501 may include a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are located external to the computer system 501 (e.g., on a remote server that is in communication with the computer system 501 through an intranet or the Internet).

The computer system 501 can communicate with one or more remote computer systems through the network 530. For instance, the computer system 501 can communicate with a remote computer system of a user (e.g., an operator of a vehicle on which the surround view radar system is mounted). Examples of remote computer systems include personal computers (e.g., portable PC), slate or tablet PC's (e.g., Apple® iPad, Samsung® Gala5 Tab), telephones, Smart phones (e.g., Apple® iPhone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine-readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processor adapted to execute the code or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540 for providing, for example, a portal for a vehicle operator to view one or more objects detected using the surround view radar systems of the present disclosure. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 505. For example, the algorithm may be configured to process a plurality of radar signals obtained using one or more radar sensors of the surround view radar systems disclosed herein and detect one or more objects based on the plurality of processed radar signals.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A surround view radar system, comprising:
a plurality of radar sensors;
a processor operatively coupled to the plurality of radar sensors; and
at least one mechanical enclosure configured to house the processor and the plurality of radar sensors, wherein the plurality of radar sensors are configured to provide a surround view of a surrounding environment external to the enclosure.

2. The system of claim 1, wherein the plurality of radar sensors are configured to provide a surround view spanning 360 degrees.

3. The system of claim 1, wherein each radar sensor of the plurality of radar sensors has a field of view ranging from about 60 degrees to about 180 degrees.

4. The system of claim 3, wherein at least two fields of view of at least two radar sensors, are immediately adjacent and coincident, overlap or partially overlap.

5. The system of claim 3, wherein at least two fields of view of at least two radar sensors do not overlap or coincide.

6. The system of claim 1, wherein the processor and the plurality of radar sensors are integrated on different circuit boards.

7. The system of claim 1, wherein the processor and the plurality of radar sensors are integrated on a same circuit board.

8. The system of claim 1, wherein the at least one mechanical enclosure comprises a heat sink.

9. The system of claim 1, wherein at least a portion of the at least one mechanical enclosure is configured to be transparent or semi-transparent at one or more operating frequencies of the plurality of radar sensors.

10. The system of claim 1, wherein the processor is configured to process data from the plurality of radar sensors to detect a characteristic of one or more target objects in the surrounding environment.

11. The system of claim 1, wherein the processor is configured to adjust, synchronize, or calibrate a transmission timing for the plurality of radar sensors.

12. The system of claim 11, wherein the processor is configured to jointly adjust, synchronize, or calibrate a transmission timing for the plurality of radar sensors.

13. The system of claim 1, wherein any one of the plurality of radar sensors are configured to receive signals from other radar sensors in the plurality of radar sensors.

14. The system of claim 1, wherein one or more of the plurality of radar sensors are configured to receive signals from other radar sensors in the plurality of radar sensors.

15. The system of claim 1, wherein the at least one mechanical enclosure comprises a plurality of mechanical enclosures.

16. The system of claim 1, wherein the processor is configured to calibrate the mounting positions and angles together for the plurality of radar sensors using the overlapping field of view on the computer.
